(19) United States
(12) Patent Application Publication
(10) Pub. No.: US 2014/0352657 A1
(43) Pub. Date: Dec. 4, 2014

(54) CENTERFLOW THROTTLE VALVE

(71) Applicant: C. Thomas Waits, Cedar Park, TX (US)

(72) Inventor: C. Thomas Waits, Cedar Park, TX (US)

(21) Appl. No.: 14/280,653

(22) Filed: May 18, 2014

Related U.S. Application Data
(60) Provisional application No. 61/830,173, filed on Jun. 3, 2013.

(51) Int. Cl. F02D 9/10

(52) U.S. Cl. CPC F02D 9/103; F02D 9/109; F02D 9/1065; F02D 9/107
USPC 123/337; 29/888.01

(57) ABSTRACT

A throttle valve includes a valve body defining a flow passage. A plurality of non-overlapping occluder members are mounted in the flow passage and have synchronized movement due to devices externally of the flow passage. The occluder members have mating edges which engage when closed together to substantially restrict flow through the passage. The occluder members are movable to multiple open positions wherein the mating edges are spaced apart to permit unobstructed and centralized flow through the passage.

### CROSS-REFERENCE TO RELATED APPLICATIONS

This application is related to and claims priority to U.S. Provisional Application No. 61/830,173 filed Jun. 3, 2013, which is incorporated herein by reference in its entirety.

### BACKGROUND

The present disclosure is for a variable-flow throttling valve for controlling fluid flow, and more particularly, for controlling fluid flow into an internal combustion engine.

In an attempt to improve the performance of internal combustion engines, especially such engines used in automobiles, throttle bodies containing throttling valve members have been used to control and vary the amount of air entering engine cylinders where air and fuel mix and burn to provide mechanical energy. The throttle bodies are typically mounted on the air intake manifold of the engine. In some cases, a single throttle body may be used such as in a straight or in-line cylinder arrangement, and a pair of throttle bodies may be used in a V-shaped engine block with multiple rows of cylinders.

Prior throttling valves have used sliding, rotating and butterfly valve members as adjustable occluders, which are movable to vary, adjust or block the passage of air passing through the valve to the engine. A common problem present in some valve occluders is that they are supported by members which extend into or across the path of the air passing through the throttling valve. The presence of such members causes restriction to airflow and turbulence in the airflow. Another common problem present in some valve occluders is that they open at opposing sides of the air passage. These non-centralized openings cause turbulence in the airflow.

Accordingly, it would be beneficial to provide a throttling valve having occluders which are movable to block and open airflow and which are not supported by members which extend into the airflow so as to cause airflow restriction and turbulence and which open at the center of the air passage so as not to cause turbulence.

### SUMMARY

One embodiment accordingly, includes apparatus having a valve body defining a flow passage. A plurality of non-overlapping occluder members are mounted in the flow passage. The occluder members have mating edges and the occluder members are also movable to multiple open positions wherein the mating edges are spaced apart, and to a closed position wherein the mating edges are engaged. Means are provided, externally of the flow passage, for moving the occluders. Also, other means are provided, externally of the flow passage, for synchronizing the movement of the occluders. The occluders substantially restrict flow through the passage in response to the mating edges of the occluders being engaged, and the occluders permit unobstructed and centralized flow through the passage in response to the occluders being in the multiple open positions.

### BRIEF DESCRIPTION OF THE DRAWINGS

FIG. 1 is a diagrammatic view illustrating an embodiment of a throttle body system.

FIG. 2 is a perspective view illustrating an embodiment of a throttle housing.

FIGS. 2a and 2b are perspective views illustrating an embodiment of arcuate occluders for use in the housing of FIG. 2.

FIG. 3 is a perspective view illustrating an embodiment of the occluders of FIG. 2a, 2b, mounted in the housing of FIG. 2 in the fully opened position.

FIG. 4 is a perspective view illustrating the occluders of FIG. 3 in a partially opened position.

FIG. 5 is a perspective view illustrating the occluders of FIG. 3 in the fully closed position.

FIG. 6 is a top view illustrating an embodiment of the occluders and housing of FIG. 3, having the occluders in the fully opened position.

FIG. 7 is a top view illustrating the occluders of FIG. 6 in the partially opened position.

FIG. 8 is a top view illustrating the occluders of FIG. 6 in the fully closed position.

FIG. 9 is a cross-sectional side view illustrating an embodiment of the occluders and housing of FIG. 3, having the occluders in the fully opened position.

FIG. 10 is a cross-sectional side view illustrating the occluders of FIG. 9 in the partially opened position.

FIG. 11 is a cross-sectional side view illustrating the occluders of FIG. 6 in the fully closed position.

FIG. 12 is a perspective view illustrating an alternate embodiment of a rectangular occluder.

### DETAILED DESCRIPTION

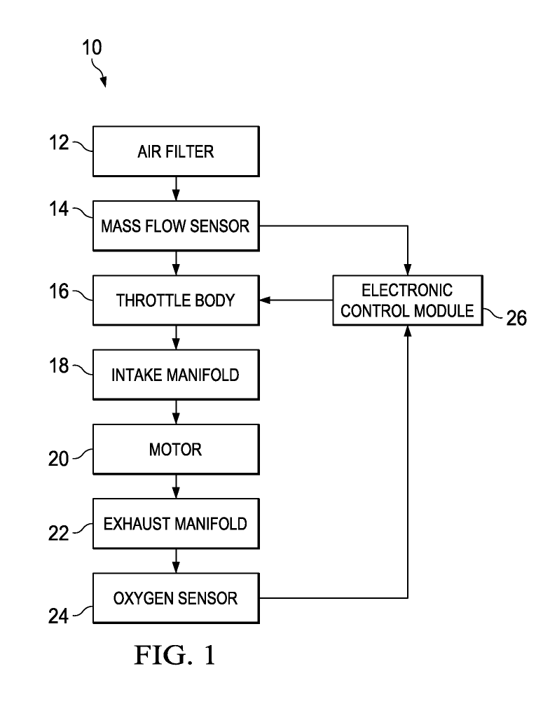

In FIG. 1, a block diagram 10 illustrates an embodiment of a throttle body system for use in a motor vehicle for example. Such a system may include a flow path via an air filter 12, a mass flow sensor 14, a throttle body 16, an intake manifold 18, a motor (internal combustion engine) 20, an exhaust manifold 22 and an oxygen sensor 24. An electronic control module 26 receives inputs from the mass flow sensor 14 and the oxygen sensor 24, and provides inputs to the throttle body 16. This exemplary system is for a normally aspirated fuel injected engine as found in most vehicles today. Depending on configuration, there may be two each of the mass flow sensors 14, throttle bodies 16 and oxygen sensors 24. A turbo charged engine would also have a turbo charger with a turbine stage between the exhaust manifold 22 and the oxygen sensor 24, and a compressor stage between the air filter 12 and the throttle body 16. In higher performance turbo charged engines, there is also an intercooler between the compressor stage and the throttle body 16.

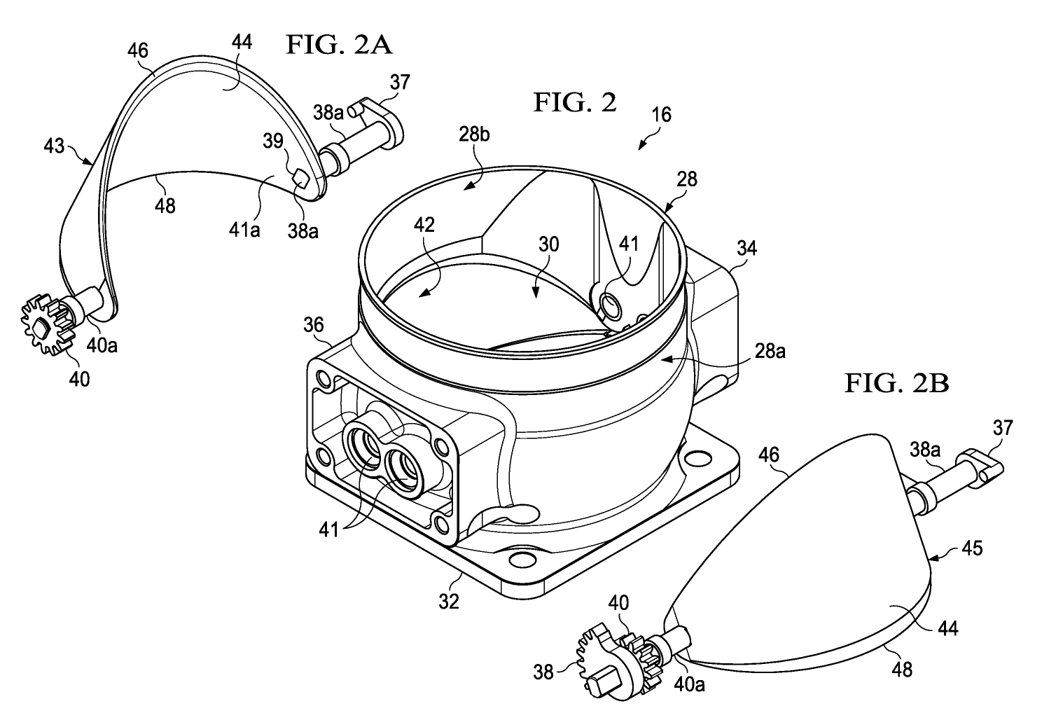

Throttle body 16, FIG. 2, includes a valve body housing 28, defining a flow passage 30. A base 32 is provided for attachment to the above-mentioned intake manifold 18. A first shaft housing 34 and a second shaft housing 36 are provided for pivoting means 38 and associated shafts 38a, and for synchronizing means 40 and associated shafts 40a respectively. The first and second shaft housings 34, 36, respectively, are provided on an outer wall surface 28a. A swept or bulbous surface 42 is provided on an inner wall surface 28b of valve body housing 28.

A pair of occluders 43, 45, FIGS. 2a and 2b, each include a smooth arcuate wall 44, a mating edge 46 and a trailing edge 48. Each occluder 43, 45 fixedly receives shafts 40a and the associated pivoting means 38 and associated synchronizing means 40. Shafts 38a, 40a extend through shaft apertures 41 provided in the shaft housings 34, 36, respectively. Shafts 38a are also attached to include dogs 37, which drive torsion springs (not shown) to limit backlash and flutter.

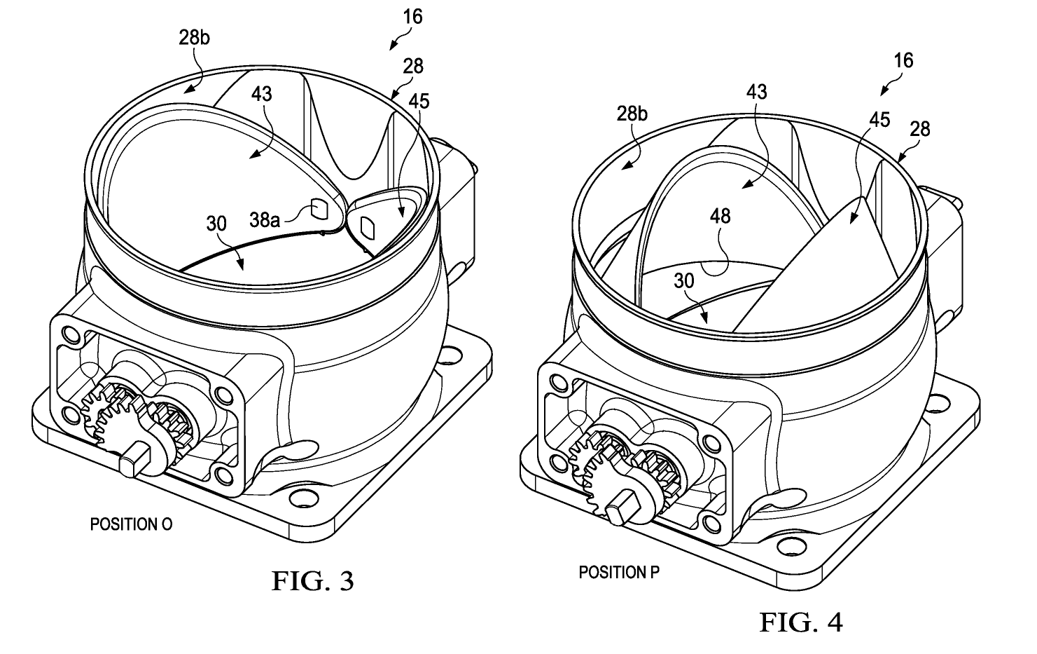

Referring to FIGS. 3, 6 and 9, occluders 43, 45 are illustrated in a fully open position 0, in response to shafts 38a, 40a being symmetrically rotated so that occluders 43, 45 substantially align with and engage inner wall surface 28b of valve body housing 28. In this open position 0, the smooth arcuate wall 44 of each occluder 43, 45 is adjacent to and covers the swept or bulbous surface 42 of inner wall surface 28b, thus forming a substantially planar wall in flow passage 30 for reducing turbulence and reducing any occluder restriction to the flow of air through flow passage 30.

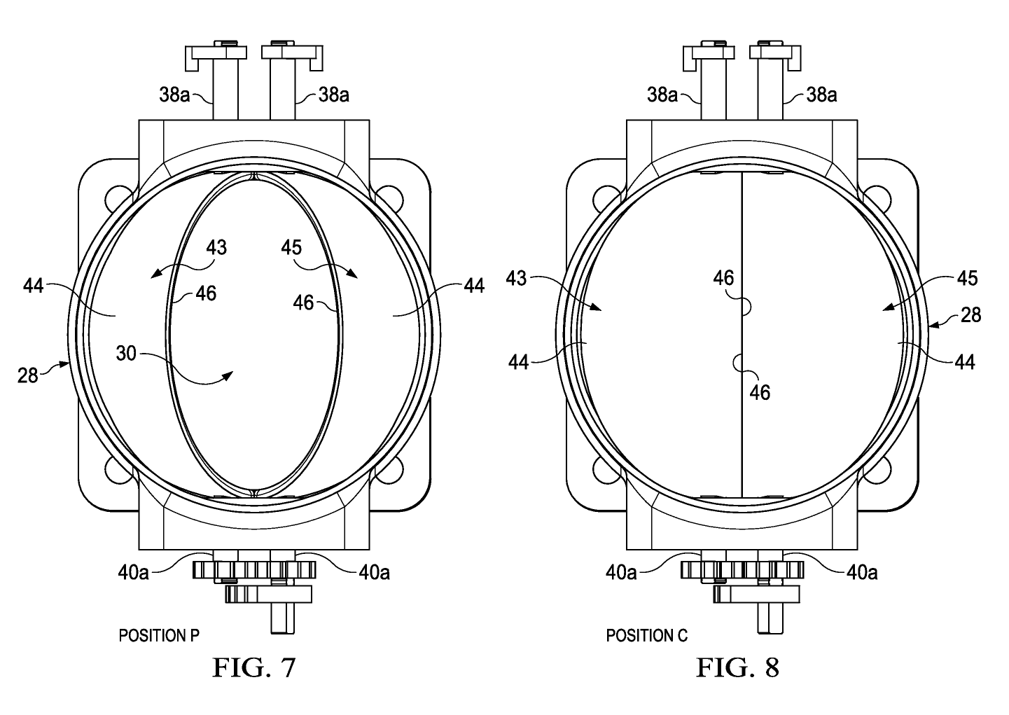

Referring to FIGS. 4, 7 and 10, occluders 43, 45 are illustrated in any one of multiple partially closed and partially open positions P, in response to shafts 38a, 40a being symmetrically rotated so that their trailing edges 48 engage and sweep the bulbous surface 42 of the throttle body 16. In this partially open position P, the smooth arcuate wall 44 of each occluder 43, 45 is moved out of engagement with a portion of inner wall surface 28b of valve body housing 28, and the mating edges 46 of occluders 43, 45 are symmetrically moved toward each other, but remain spaced apart, thus maintaining substantially reduced turbulence and increasing occluder restriction to the flow of air through flow passage 30.

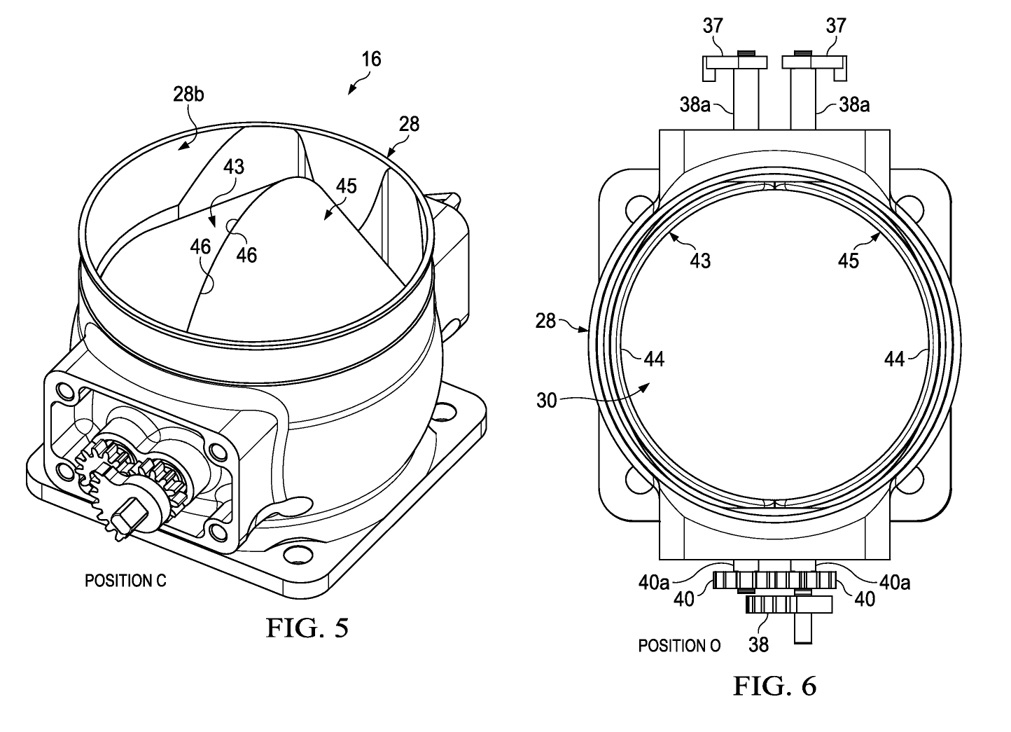

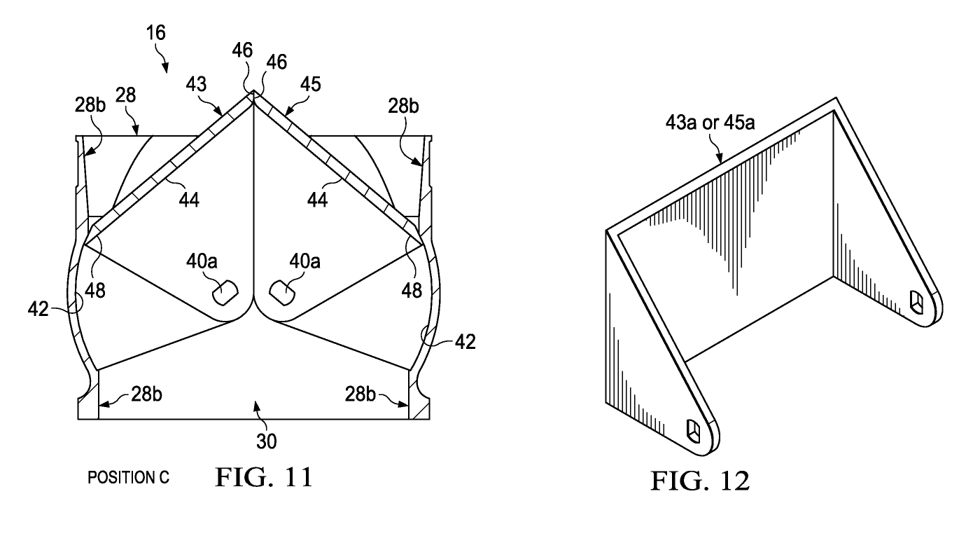

Referring to FIGS. 5, 8 and 11, occluders 43, 45 are illustrated in a fully closed position C, in response to shafts 38a, 40a and being symmetrically rotated so that their mating edges 46 engage and close flow passage 30 and their trailing edges 48 are engaged with a terminal end of bulbous surface 42 adjacent inner wall surface 28b. In this fully closed position C, the mating edges are closed in a clamshell-like manner and thus, flow is restricted through the flow passage 30.

Returning briefly to FIG. 2a, it should be noted that each shaft 38a and 40a extend into an aperture 39, two of which are provided in each occluder 43, 45 and terminate flush with an inner surface 41 a of arcuate wall 44. In this manner, none of the shafts 38a and 40a extend into flow passage 30. Also, as clearly shown in FIG. 6, the gears 40 of each shaft 40a are synchronized in their movement due to their meshed engagement.

Although the housing 28, FIG. 6, is illustrated as having a substantially circular cross-section, and similarly, the flow passage 30 with occluders 43, 45 shown in the fully open position 0, see also FIGS. 3, 6 and 9, have a substantially circular cross-section, it is possible to provide housing 28 and occluders 43, 45 in other than a circular configuration. For example, an alternative housing and occluders may have an oval cross-section (not shown). A further alternate housing and occluders may have a rectangular cross-section such as occluders 43a and 45a illustrated in FIG. 12.

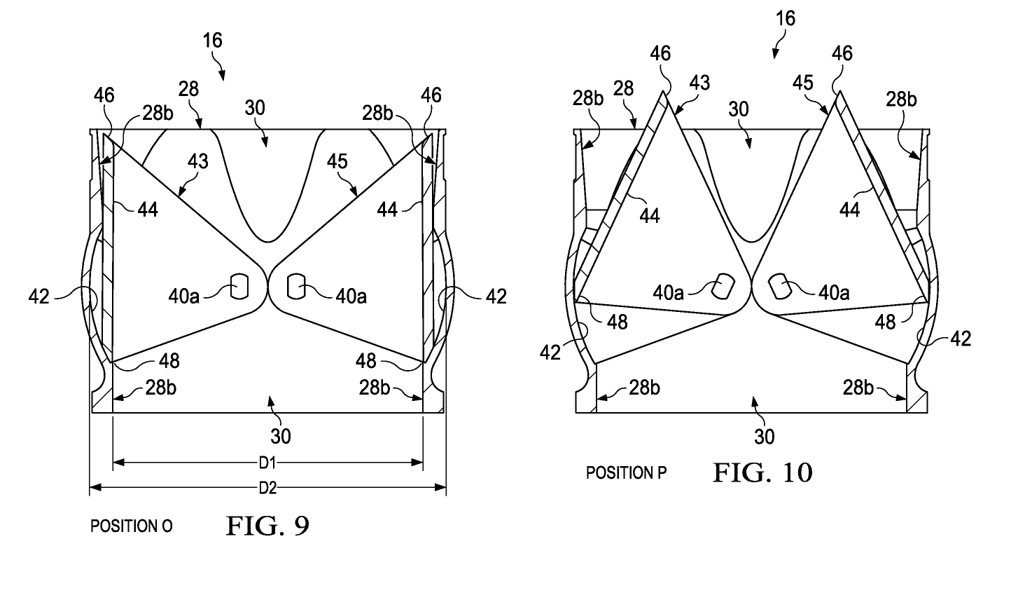

Referring again to FIGS. 9, 10 and 11, a preferred embodiment illustrates the valve body housing 28 having a substantially circular cross-section forming the flow passage 30. The inner wall surface 28b is a multiple size opening and includes a first diameter D1, and the bulbous portion 42 of inner wall surface 28b includes a second diameter D2, which is greater than first diameter D1. As is best illustrated in FIG. 9, movement of occluders 43 and 45 to the fully open position 0, converts the multiple size opening 28b to a substantially single size opening formed by the smooth arcuate walls 44.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. Apparatus comprising:
a valve body defining a flow passage;
a plurality of non-overlapping occluder members mounted in the flow passage, the occluder members having mating edges and the occluder members being movable to multiple open positions wherein the mating edges are spaced apart, and to a closed position wherein the mating edges are engaged;
means connected for moving the occluders, the means for moving being external to the flow passage;
means for synchronizing movement of the occluders, the means for synchronizing being external to the flow passage; and
the occluders substantially restricting flow through the passage in response to the mating edges of the occluders being engaged, and the occluders permitting unobstructed and centralized flow through the passage in response to being in the multiple open positions.

2. The apparatus of claim 1 wherein each occluder includes a trailing edge spaced from its respective mating edge by an occluder wall portion.

3. The apparatus of claim 1 wherein the valve body flow passage includes a multiple size opening including a first size opening and a second size opening larger than the first size opening.

4. The apparatus of claim 3 wherein, in response to the mating edges of the occluders being engaged in a fully closed position, the trailing edges of the occluders being engaged with a first end of the second size opening.

5. The apparatus of claim 4 wherein in response to the occluders being in a fully open position, the trailing edges of the occluders being engaged with a second end of the second size opening spaced from the first end of the second size opening.

6. The apparatus of claim 5 wherein, in response to the occluders being in the fully open position, the wall portion of the occluders cover the second size opening, the multiple size opening being converted to a single size opening formed by the occluder wall portions.

7. The apparatus of claim 1 wherein the mating edges engage in a clamshell-like occlusion in response to the occluders being in a fully closed position.

8. The apparatus of claim 1 wherein the valve body flow passage includes a substantially circular inner wall having a first wall portion of a first diameter, and a second wall portion of a second diameter, larger than the first diameter.

9. The apparatus of claim 8 wherein the occluders each include an arcuate wall portion.

10. The apparatus of claim 9 wherein the second size opening includes a bulbous surface.

11. The apparatus of claim 10 wherein, in response to the occluders moving between a fully open position and a fully closed position, the trailing edge of each occluder maintains engagement with the bulbous surface.

12. The apparatus of claim 10, wherein in response to the occluders being in a fully open position, the wall portion of the occluders cover the bulbous surface.

13. A system comprising:
an internal combustion engine;
an intake manifold mounted on the engine;
one or more throttle valves mounted on the intake manifold, each valve having a body member defining a flow passage;
a plurality of non-overlapping occluder members mounted in the flow passage, the occluder members having mating edges and the occluder members being movable to multiple open positions wherein the mating edges are spaced apart, and to a closed position wherein the mating edges are engaged;
means connected for moving the occluders, the means for moving being external to the flow passage;
means for synchronizing movement of the occluders, the means for synchronizing being external to the flow passage; and
the occluders substantially restricting flow through the passage in response to the mating edges of the occluders being engaged, and the occluders permitting unobstructed and centralized flow through the passage in response to being in the multiple open positions.

14. The system of claim 13 wherein each occluder includes a trailing edge distal from the mating edge.

15. The system of claim 14 wherein the trailing edge of each occluder is spaced from its respective mating edge by an occluder wall portion.

16. The system of claim 15 wherein the flow passage is substantially circular and the occluder wall portion of each occluder is arcuate.

17. The system of claim 15 wherein each occluder wall portion is rectangular.

18. A method comprising:
mounting at least one throttle valve on an intake manifold of an internal combustion engine, the at least one throttle valve having a body defining a flow passage;
mounting a plurality of non-overlapping occluder members in the flow passage, the occluder members having mating edges and the occluder members being movable to multiple open positions wherein the mating edges are spaced apart, and to a closed position wherein the mating edges are engaged;
providing means for moving the occluders, the means for moving being external to the flow passage;
providing means for synchronizing movement of the occluders, the means for synchronizing being external to the flow passage;
substantially restricting flow through the flow passage in response to engaging the mating edges of the occluders; and
permitting unobstructed and centralized flow through the flow passage in response to the occluders being moved to any of the multiple open positions.

19. The method of claim 18 wherein each occluder includes a trailing edge distal from the mating edge.

20. The method of claim 19 wherein the trailing edge of each occluder is spaced from its respective mating edge by an occluder wall portion.
